(19) United States
(12) Patent Application Publication
(10) Pub. No.: US 2005/0063531 A1
(43) Pub. Date: Mar. 24, 2005

(54) Filter systems for broadband telecommunication facilities

(76) Inventor: Juan Tomas Arias, Madrid (ES)

Correspondence Address: MYERS BIGEL SIBLEY & SAJOVEC, PO BOX 37428, RALEIGH, NC, 27627, US

(21) Appl. No.: 10/498,647

(22) PCT Filed: Sep. 17, 2003
(86) PCT No.: PCT/GB03/04027

(30) Foreign Application Priority Data
Oct. 3, 2002 (ES) 200202265
Jun. 11, 2003 (ES) 200301379

(51) Int. Cl. H04M 3/00; H04M 5/00

(52) U.S. Cl. 379/325

(57) ABSTRACT

Broadband telecommunications facilities wherein the filters or splitters that serve for the combination or segregation of the voice and data signals are arranged in a form separate from the DSLAM, being connected externally to the connection block of the intermediate distribution frame, and preferably being individual filters, which permits no increase in the space used in the distribution frame, easy replacement and maintenance, and due to the arrangement of the contact pairs on the connection block of the intermediate distribution frame maximum use is obtained of the same, being grouped together in groups of two pairs, wherein the half-pair that remains free is used either as a point of grounding or as a contact for metallic access.

The present invention relates to electric filter systems for broadband telecommunication facilities.

To provide a high-speed data transmission service, for example over ADSL (asynchronous digital subscriber line) or in general xDSL systems, it is necessary at different stages to combine and to segregate the voice signal, sent by the switching exchange, and the high-speed xDSL data signal, provided by the digital subscriber line access multiplexer (DSLAM). Such combination and segregation of the voice and data signals is effected by means of a filter (sometimes referred to as a splitter), that adds or segregates the signals on their way to or from the subscriber.

The filter serving to combine or segregate the voice and high-speed data signals is often installed jointly with the DSLAM. Given the high price of the combined DSLAM and filter equipment and the double wiring that it is necessary to run between the DSLAM and the intermediate distribution frame, some operators have opted for the separate purchase of the different components, installing filters and DSLAM in different cubicles. In general cards are used which carry multiple filters, that is for several lines or accesses. These cards have the drawback that when a fault occurs in one of the lines it is necessary to replace the entire card, which signifies a high maintenance cost and disrupts the operation of all the lines on that card.

It is an objective of the present invention to provide a more convenient connection architecture or installation for broadband connections, wherein the filters are installed separately from the DSLAM, but not in separate cubicles as in the known systems.

According to the present invention, the filters are installed on the actual intermediate distribution frame, from which the combined voice and data signals pass to and from the vertical connection block. The terms intermediate distribution frame and vertical connection block are well understood by those familiar with this field of telecommunications technology. Preferably, an individual filter is provided for use by each respective individual line or access, which facilitates and reduces the cost of the maintenance, and does not significantly increase the space occupied in the intermediate distribution frame. It is additionally preferred that the constructional characteristics of the filters, as well as of the connection blocks of the intermediate distribution frame, be improved to allow a better use of the space, and to offer a point of manual access. It is furthermore preferred that each of the individual filters carries its own means of protection against over-voltages or over-currents.

The installation with electric filters for broadband connections according to the present invention is thus seen as advantageous over the previously known state of the art described in German Utility Model DE-U-20104605, wherein the installation consists of a connection block that has an upper cover and another lower one both designed for the guidance of the cables, presenting frontally two rows of contact pairs of 10 pairs per row. On the inside of the assembly is arranged a filter card carrying all of the filters, in total four, for the four lines that can be connected. The connection block has a series of contact pairs thereon distributed in two rows of 10 contact pairs per row, some of said pairs being employed for the connection to ground. It offers two contact pairs per line to which the combined signal is connected.

The installation of DE-U-20104605 presents several drawbacks. Its filter card is inside the connection block, so that in the event of a line fault requiring replacement of the filter, it is inconveniently necessary to open the connection block to gain access to the card. Also, the fact that this single card carries the filters of several lines means that all of the good filters must be replaced at the same time as the faulty filter. Moreover the filters of DE-U-20104605 have no means of protection against over-voltages and over-currents. A further defect of the configuration described in DE-U-20104605 is that its connection block does not allow optimum use of space, since the 10 contact pairs provided can connect a total of only four lines.

The configuration now proposed according to the present invention is intended to address some or all of the above disadvantages. The facility according to the present invention accordingly may be arranged to allow a connection block on the intermediate distribution frame to connect a total of 5 lines; and/or to leave one or more of the pairs free to serve as a contact for metallic access or as manual access to take said signal to the test desk; and/or to allow the filters on the connection block of the intermediate distribution frame to be replaced individually; and/or to provide the individual filters with means of protection against over-voltages and over-currents.

Moreover, the configuration of the wiring of the connection blocks in the intermediate distribution frames according to preferred aspects of the present invention may be arranged to allows an optimisation of the contact pairs, and to leave a half-pair of free contacts per line, to which can be allocated different uses, such as serving for grounding or serving as contact for metallic access and/or connection to a test desk. The half-pair of contacts that is free can be wired to a test desk with the object of enabling automatic supervision of the state of the lines. In further preferred embodiments of the invention, the filters themselves may have some test points that allow access in a manual way to any one of the three signals, voice, data, or combined voice and data, in addition to the possible use of the free pairs.

The distribution of the contact pairs on the connection block is preferably such that, in each two pairs, two half-pairs are arranged in an upper row and the other two half-pairs on the lower row and in correspondence, one of the upper half-pairs is used for the voice signal and the other for the high-speed XDSL data signal, while one of the lower half-pairs is used for the combined voice/data signal and the other is the aforementioned free half-pair, to which different uses can be allocated.

This distribution of the use the contact pairs on the connection block of the intermediate distribution frame achieves maximum benefit from said block. When there is an odd number of contact pairs on the connection block, it may advantageously be supplemented with an adjoining connection block having the same odd number of pairs, each pair co-operating with that immediately opposite in the adjoining connection block.

Specific embodiments of the present invention will now be described by way of illustration and not restrictively, with reference to the accompanying drawings, wherein:

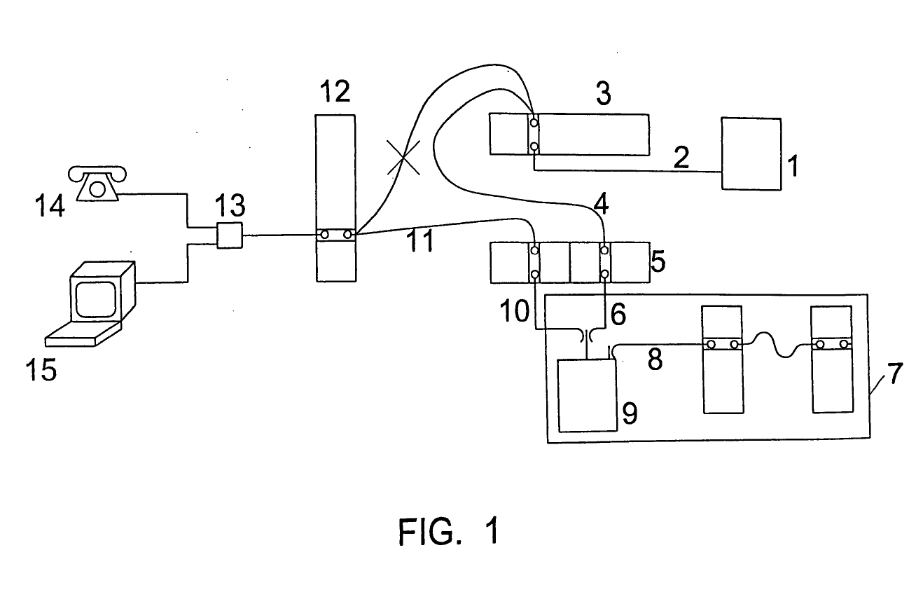

FIG. 1 shows a conventional “Prior Art” installation for XDSL networks,

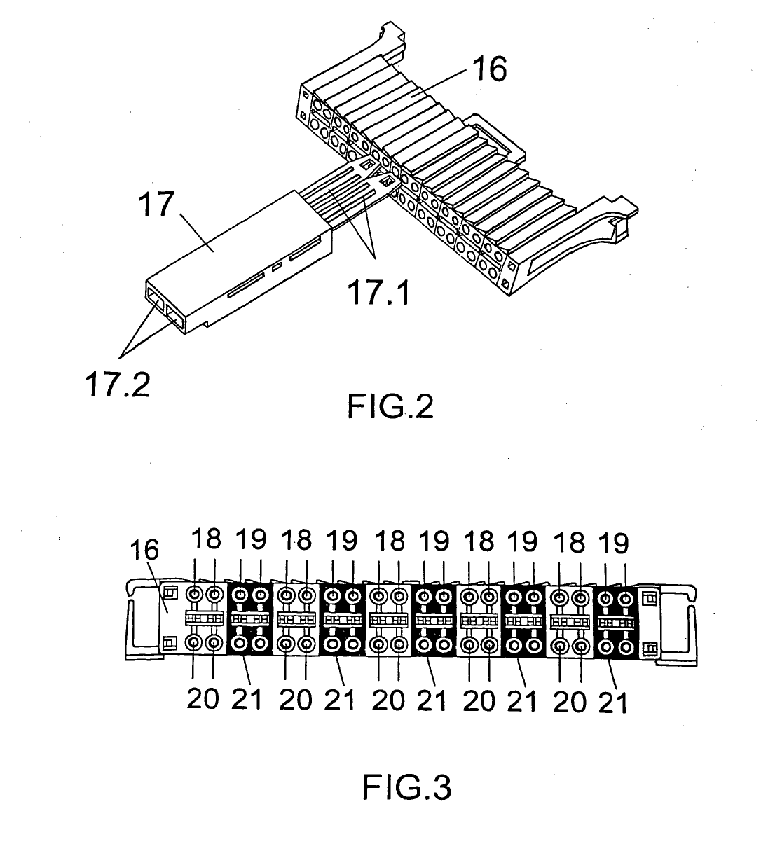

FIG. 2 shows a connection block and filter for the present invention,

FIG. 3 shows the configuration presented by the connection block of the intermediate distribution frame,

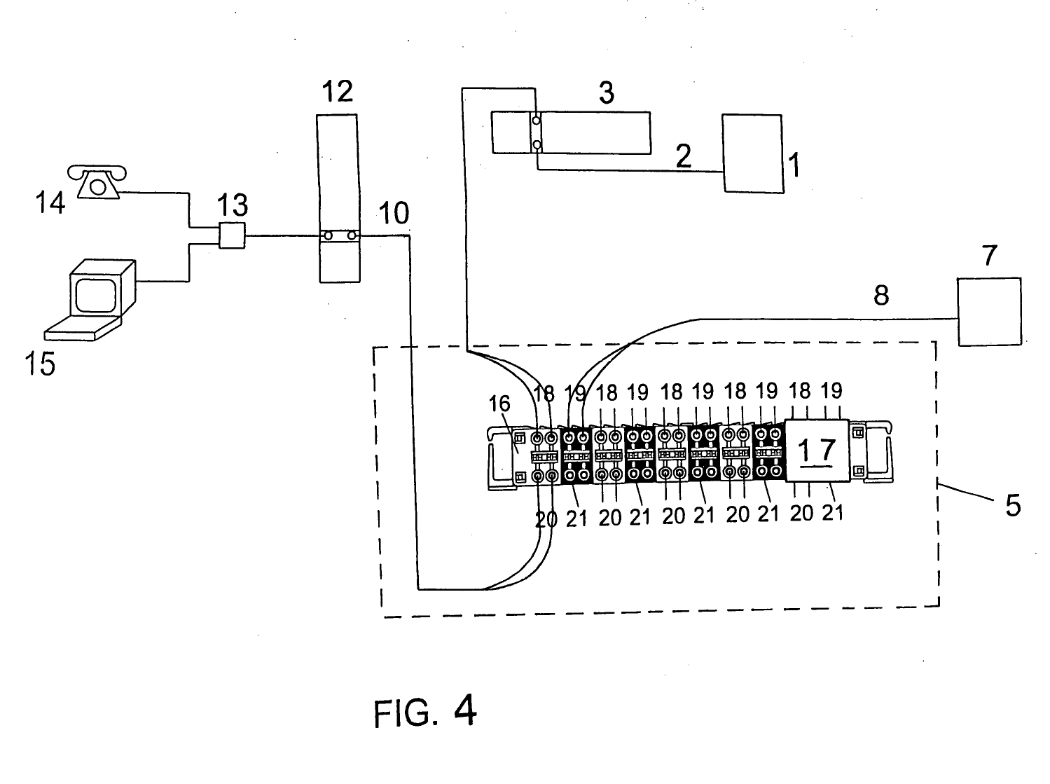

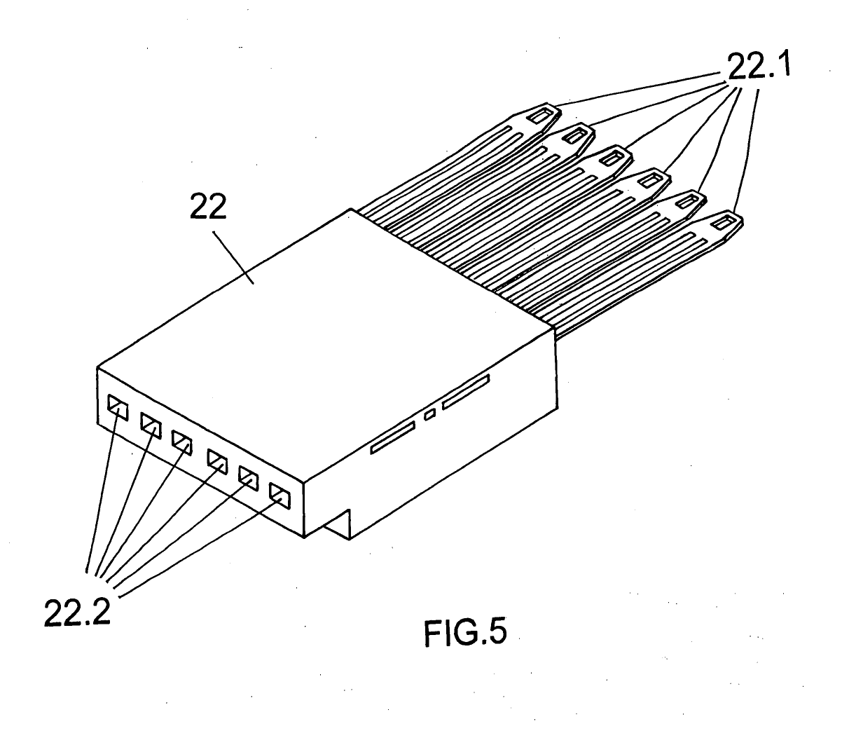

FIG. 4 shows the configuration of the wiring for broadband networks with the filters which are the subject of the invention,

FIG. 5 shows a representation of a possible multi-filter module, and

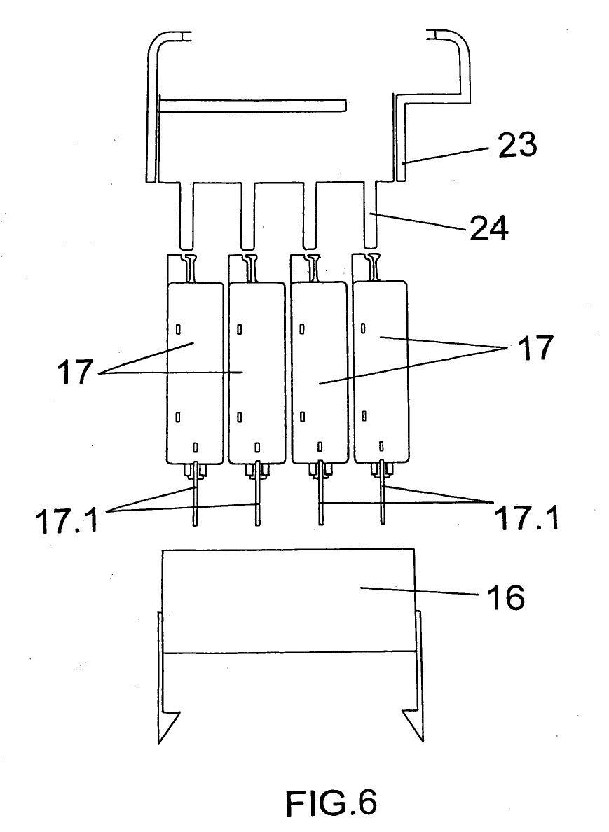

FIG. 6 shows a representation in which, by means of a metal access block, there is access to the voice, data and combined signals, and the possible use of the free pair, for subsequent automatic checking of the latter.

In the known facility shown in FIG. 1, it is observed how from the switching exchange (1) the voice signal (2) is furnished, which reaches the horizontal connection block (3) and continues to the intermediate distribution frame (5), by means of a voice jumper (4), continuing later, by means of a cable (6) until arriving at the filter (9) which serves to combine or segregate the voice signal (2) and the high-speed xDSL signal (8) provided by the digital subscriber line access multiplexer (DSLAM) (7), from a network, the combined signal (10) being obtained which is taken once again to the intermediate distribution frame (5), that then continues to the vertical connection block (12), by means of a jumper (11). From said vertical connection block (12) the combined signal passes through a filter (13) wherein the voice signal is segregated from the high-speed XDSL signal, terminating either in the telephone set (14) or in the computer (15). It is observed that the filter (9), forms an assembly, remote from the intermediate distribution frame (5).

Now, according to the present invention, and with the objective of achieving an installation in which the filter (9) is installed separately from the DSLAM (7) and in an individual manner, and wherein the drawbacks of previously known arrangements are addressed, filters and a wiring configuration of the connection blocks on the intermediate distribution frame have been developed as shown in FIGS. 2 and 3.

In FIG. 2 a filter (17) is shown of individual use for each of the lines, which is mounted in a form external to the connection block (16) of the intermediate distribution frame, and which has a series of contacts (17.1) arranged so that they fit in the openings of the pairs corresponding to the voice signal, the combined voice plus data signal, the data signal and the possible use of the free pairs. Said filters have on their inside, the means necessary for their protection against over-voltages and over-currents.

In FIG. 3, the arrangement is shown of the contact pairs on the connection block (16) of the intermediate distribution frame (5), with the object of achieving maximum benefit from the pairs of said connection block (16). The pairs are arranged in two rows each of ten half-pairs of contacts, using two half-pairs of the upper row and the two facing half-pairs of the lower row for a same line. Observe thus that the half-pairs (18) and (19) are used respectively for the voice signal and the high-speed xDSL data signal. On the lower part and arranged opposite, the half-pair (20) is used for the combined voice plus data signal, while the half-pair (21) is free for diverse uses, like for example serving as a point for grounding, or as a point of metallic access, from where the signal can be taken to a test desk with the object of verifying the state of the lines in an automatic way.

FIG. 4 shows the configuration of the wiring in which the filter or splitter (9) is fitted separately from the DSLAM (7), the filter or splitter (9) being directly connected on the strip (16). Once again, it can be seen that the strip (16) is fitted in the intermediate distributor (5), the latter having a series of strips (16) which have one or more sets of four pairs of contacts, wherein each set has one free pair (21), one pair for the cables of the voice input signal (18), another for the cables of the xDSL data input signal (19), and another for the cables of the combined output signal.

Moreover, the filters (17) include some for testing (17.2) where in a manual way access is available to any of the three signals, voice, data or combined voice and data signal and the possible use of the free pair.

With the object of being able to use the free half-pair as metallic access leading to the test desk, it is necessary for the connection block to have the contacts in a certain way, in brief the contacts of the voice signals and the combined signal should be normally closed while the contacts of the data signal should be normally open, all this with the objective of preventing any short circuit in the extraction of the filters. This configuration allows optimum use of all the pairs that there are in the connection block (16) and in the event that the number of pairs is odd, it allows each half-pair to be grouped with the corresponding half-pair of the adjoining connection block.

Finally it is pointed out that although a description has been made based on individual filters, the same configuration and disposition is also achieved with multi-filter modules, that is with equipment that groups the filters corresponding to several lines, as can be seen in FIG. 5, in which the multi-filter unit (22) has a series of contacts (22.1) and some test points (22.2), which make it possible to access manually any of the three signals, i.e. voice, data or combined voice or data signal, and the possible use of the free pair.

FIG. 6 shows how, by means of a metal access block (23), it is possible to obtain the voice, data and combined signals, as well as the possible use of the free pair, thus making it possible to transmit these signals to a test plate where they are checked automatically. The contacts (24) of the metal access block are introduced into the test points (17.2) with which the filters (17) are provided. There can also be seen the contacts (17.1) of the filters (17) which are connected to the strips (16).

The present invention includes further improvements in the aforementioned facilities with electric filters for broadband connections, the filters designed for these facilities, as well as the connection blocks, also specially designed, to connect the filters. An object of these further improvements of the invention is to permit the use of pairs in adjoining connection blocks, instead of pairs on the same connection block, maintaining the functionality of the facilities, but considerably facilitating the wiring of the connection blocks, the voice (POTS) remaining connected to the line when the filter is removed.

In the systems hereinbefore described, amongst other characteristics, it is designed that the distribution of the contact pairs on the connection block of the intermediate distribution frame is in two rows, using two pairs of the upper row and the two opposite pairs of the lower row for the same line, so that the first two are used for the incoming voice signal and the incoming high-speed xDSL data signal respectively, whilst from the other two, one is used for the outgoing combined voice plus data signal and the other remains free for various uses, such as, for example grounding, or as point of metallic access from where the signal can be taken to a test desk with the object of verifying the state of the lines in an automatic way. This structure, although successfully reducing costs by separating the multiplexer or DSLAM from the filters, has, however, certain difficulties in the wiring, as this has to be done alternately, i.e. alternate contact pairs of one type or the other throughout a connection block, wiring which would be undoubtedly made easier if all the pairs of each line of the connection block were of the same type.

The further improvements now proposed consist of using parallel connection blocks on the intermediate distribution frame, grouped in pairs, so that, within a certain pair of connection blocks, on one of them, the incoming voice signal of the corresponding lines is established on one of the alignments of the contact pairs, and the outgoing combined voice plus data signal of each one of the lines is established on the other alignment, whilst on the second connection block, and opposite the first one, the incoming high-speed XDSL data signal is established on the contact pairs of one of its alignments, the contact pairs of its second alignment finally remaining free for grounding, as a point of metallic access or for any other auxiliary application. This means that the pins of each filter, instead of being positioned in a coplanar form, can have a parallel arrangement, at a distance coinciding with that between connection blocks, in the mounting thereof on the intermediate distribution frame.

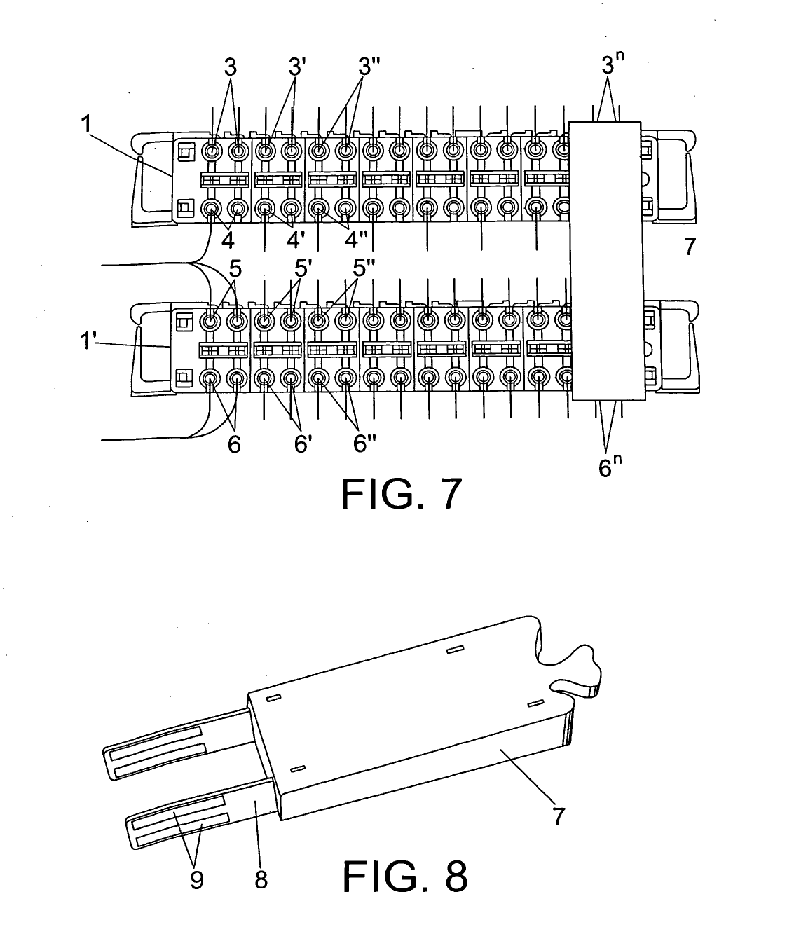

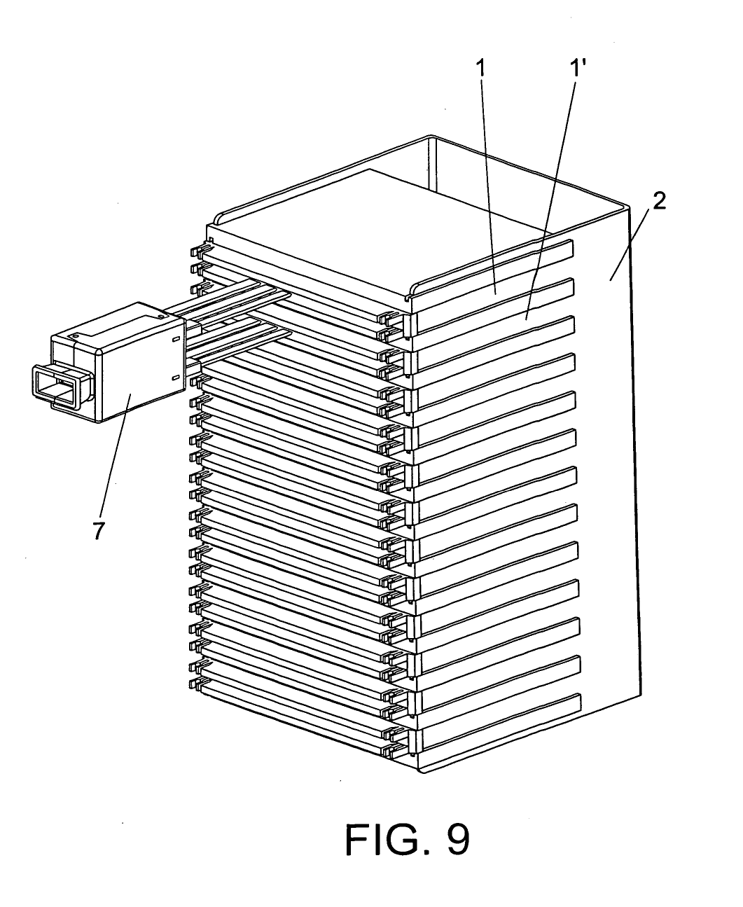

A preferred embodiment of this arrangement will now be described by way of example, with reference to the accompanying drawings wherein:
FIG. 7 shows, in schematic front elevation, the connection blocks according to the present further improvements of the invention, wherein one of the individual filters, corresponding to a line, is implanted;
FIG. 8 shows in perspective one of the individual filters to be implanted in any of the lines established in the pair of connection blocks of FIG. 7; and
FIG. 9 shows in schematic perspective an intermediate distribution frame with its connection blocks and one of its filters.

In the light of said figures, we can observe how the connection blocks (1) that form part of the intermediate distribution frame (2), are arranged parallel to each other and grouped in pairs, as is shown in FIG. 7. This allows that both connection blocks (1-1′) belonging to the same pair are functionally integrated, establishing, on each one of them, the first alignment of contact pairs (5), (5′), (5″), . . . (5ⁿ), used, for example, for the incoming voice signal of the respective lines, and another longitudinal alignment of contact pairs (6), (6′), (6″) . . . (6ⁿ), used, for example, for the outgoing combined voice plus data signal. At the same time, on the second connection block (1′), a first alignment of contact pairs (3), (3′), (3″) . . . (3ⁿ) is established, used, for example, for the incoming high-speed xDSL data signal, and finally, another alignment of contact pairs (4), (4′), (4″) . . . (4ⁿ) can remain free, acting as grounding or point of metallic access from where the signal can be taken to a test desk with the purpose of verifying the state of the lines in an automatic way. This means, as stated above, that the connections in the contact pairs (5) are all identical, corresponding to the different lines, as occurs with the contact pairs (6), with the contact pairs (3) and with the contact pairs (4), with no other determining factor than that of the lines being independent, which considerably facilitates the wiring. In accordance with this arrangement for the connection blocks (1-1′), each filter (7) can simultaneously be mounted on two parallel connection blocks (1-1′), as is particularly observed in FIG. 8, for which purpose the pins (8) of the filter, each one equipped with a pair of terminals (9) in the example in FIG. 8 or with 3 terminals in the example in FIG. 9, are arranged parallel, so that one of them is plugged in between the contacts (5) and (6) of one of the connection blocks (1′) and the other between the contact pairs (3) and (4) of the other connection block (1), as is also observed in FIG. 9.

It is not considered necessary to expand this description further for any person skilled in the matter to understand the scope of the invention and the advantages that are derived therefrom. The materials, form, size and arrangement of the structural elements are capable of variation provided they do not alter the essential nature of the invention.

1. Facilities with electric filters for broadband connections, wherein a voice signal, which is obtained from a switching system, reaches a horizontal connection block, from which there extends a voice jumper, which extends to a connection block on an intermediate distribution frame, where the voice signal is combined with a separately-generated data signal arriving on a data signal line, and from which intermediate distribution frame the combined signal is transmitted by means of a jumper to a vertical connection block and from there to a filter which transmits the appropriate a selected part of the signal either to a telephone or to a computer of user, wherein pairs of contacts of input and output wiring, which is connected to the connection block of the intermediate distribution frame in use, have removably connected between at least some of the pairs in use filters at least partly external to the connection block.

2. Facilities according to claim 1, wherein individual filters are provided for at least some of the lines.

3. Facilities according to claim 1 wherein the data signal comprises a high speed xDSL data signal and wherein the connection block of the intermediate distribution frame has for each four contact half-pairs one free half-pair, remaining ones of the four contact half pairs being for the voice signal, the high-speed xDSL data signal, and for the combined voice/data signal.

4. Facilities according to claim 3, wherein the free half-pair is used as a point for grounding.

5. Facilities according to claim 3, wherein the free half-pair is used as a point of metallic access to obtain access to at least one of the signals to automatically perform verification of a state of the at least one of the signals.

6. Facilities according to claim 1, wherein several filters corresponding to different signal lines are grouped together in a single filter module.

7. Facilities according to claim 1 wherein the connection block has an odd number of contact pairs and is positioned adjacent to a similar connection block and each contact pair of one of the blocks is used in conjunction with a corresponding contact pair of the other block.

8. Filter unit for installation in facilities according to claim 3, wherein the filter unit is formed to project externally from the connection block of the intermediate distribution frame and has a series of contacts facing openings of contacts of the contact half-pairs for the voice signal, the combined voice and data signal, the data signal, and/or the free half-pair.

9. Filter unit according to claim 8, wherein filters connected between different pairs of contacts are grouped together on a single card.

10. Filter unit according to claim 8, further comprising a test jumper that allows manual access to the voice signal, and/or the data signal, and/or the combined voice and/or data signal and/or the free half-pair.

11. Connection block for use in facilities according claim 1, wherein the block has a series of grouped contact pairs connectable so that for each four contact half-pairs one half-pair remains free, and the remaining half-pairs are respectively connectable to the voice signal, the data high-speed xDSL signal, and the combined voice/data signal.

12. Connection block according to claim 11, wherein the half-pairs of the voice signal and of the combined voice/data signal have closed contacts, whilst the half-pair of the data signal has open contacts, so that said free half-pair can be used as a point of metallic access to obtain a signal and to lead it to a test desk.

13. Connection block according to claim 11, having an odd number of contact pairs, so that each contact pair can be used in conjunction with a corresponding contact pair of a similar connection block when positioned adjacent thereto.

14. Connection block combination including two connection blocks according to claim 13, wherein the blocks are positioned adjacent each other so that each contact pair of one of the blocks can be used in conjunction with a corresponding contact pair of the other block.

15. Facilities according to claim 1 wherein connection blocks of the intermediate distribution frame are grouped in parallel, functionally complementary pairs, so that on a first one of said connection blocks, the contact pairs are used for the incoming voice signal, corresponding to different lines coupled to the pair of connection blocks, and opposite contact pairs are used for the outgoing combined voice+data signal, whilst on the other connection block, and facing the first one, the contact pairs are used for the data signal, and the contact pairs, which remain free as grounding points or points of metallic access, are arranged, so that each filter acts simultaneously on both combined connection blocks.

16. Facilities according to claim 15, wherein each filter is individual for each line and incorporates its contacts established on two substantially parallel pins (8) at substantially a same separation distance as that between the relevant contacts of the respective connection blocks.

17. Filter unit according to claim 8 further comprising means of protection against over-voltages and/or over-currents.

18. A broadband connection apparatus comprising:
a connection block on an intermediate distribution frame, the connection block having a set of contact half pairs associated with a user including a contact pair providing a connection to a voice signal from a switching system, a contact pair providing a connection to a data signal and a contact pair providing a connection to a combined voice and data signal to the user; and
a removable filter unit connected between at least some of the contact half pairs, the removable filter unit extending from the connection block to be positioned at least partly externally thereto.

19. The apparatus of claim 18 wherein the set of contact half pairs further includes a free contact half pair.

20. The apparatus of claim 19 wherein the connection block comprises a plurality of sets of contact half pairs associated with different users.

21. The apparatus of claim 20 wherein the filter unit includes a plurality of filters in a common unit having a plurality of contacts extending therefrom configured to mate with respective ones of the contact half pairs.

22. The apparatus of claim 21 wherein the filter unit further comprises at least one means for protection against over-voltages and/or over-currents.

23. The apparatus of claim 21 wherein the filter unit further comprises at least one test jumper configured to allow access to at least one of the signals.

24. The apparatus of claim 18 wherein the filter unit further comprises at least one means for protection against over-voltages and/or over-currents.

25. The apparatus of claim 18 wherein the filter unit further comprises at least one test jumper configured to allow access to at least one of the signals.

26. The apparatus of claim 18 wherein the connection block comprises a plurality of sets of contact half pairs associated with different users and wherein the connection block comprises a pair of connection blocks positioned adjacent each other and wherein voice signal contact pairs for the different users for each of the different signals are arranged adjacent each other on a same one of the connection blocks and wherein the removable filter unit extends between the connection blocks.

27. The apparatus of claim 18 wherein the connection block comprises a plurality of sets of contact half pairs associated with different users and wherein a set of contact half pairs is arranged with respective ones of the contact half-pairs in adjacent relationship.
